(19) United States
(12) Patent Application Publication
(10) Pub. No.: US 2006/0256579 A1
(43) Pub. Date: Nov. 16, 2006

(54) Backlight structure and lighting module therefor

(75) Inventors: Ching-Sang Yang, Bade City (TW); Kuang-Tao Sung, Fongyuan City (TW)

Correspondence Address: BACON & THOMAS, PLLC, 625 SLATERS LANE, FOURTH FLOOR, ALEXANDRIA, VA, 22314, US

(73) Assignee: AU OPTRONICS CORP., Hsin-Chu (TW)

(21) Appl. No.: 11/202,254

(22) Filed: Aug. 12, 2005

(30) Foreign Application Priority Data
May 11, 2005 (TW) 94115295

(51) Int. Cl. F21V 7/04

(52) U.S. Cl. 362/613; 362/631

(57) ABSTRACT

A backlight structure includes a first light guide plate, a second light guide plate and a lighting module. The second light guide plate is opposite to the first light guide plate, and the lighting module includes a first set of light elements, a second set of light elements, and a FPC having a turning port situated between the first set of light elements and the second set of light elements. After the turning port is turned, the FPC is configured to a new shape so that the first set of light elements supplies light to the first light guide plate and the second set of light elements supplies light to the second light guide plate. Thus, a dual-face illumination effect may be achieved.

This application claims the benefit of Taiwan application Serial No. 94115295, filed May 11, 2005, the subject matter of which is incorporated herein by reference.

### BACKGROUND OF THE INVENTION

1. Field of the Invention

The invention relates in general to a backlight structure, and more particularly to a FPC (Flexible Printed Circuit) having light-emitting elements in a backlight structure.

2. Description of the Related Art

Because the LCD (Liquid Crystal Display) panel is a non-self-emissive panel, a backlight module has to be used to provide light in order to achieve the image display function.

Under the dual-display configuration of the current mobile telephone, the backlight module has to provide light to two LCD panels. Because the display surfaces of the two LCD panels are opposite, the backlight module has to be configured into the dual-face illumination so as to provide light to the LCD panels at opposite display surfaces. FIG. 1 is a schematic illustration showing a conventional backlight structure configured as an example of a dual-face illumination. Referring to FIG. 1, the backlight structure 100 includes a light guide plate 102, a reflector 106, a light-emitting element 108 and a FPC (Flexible Printed Circuit) 110. The reflector 106 is disposed in the light guide plate 102. When the backlight structure 100 is working, the light-emitting element 108, such as a light-emitting diode, is disposed on the FPC 110 to receive the desired power and then generate the light, which enters the light guide plate 102 through a side of the light guide plate 102. Then, the light is divided into two portions, which are outputted from the light guide plate 102, wherein a part of light is outputted from the surface of the light guide plate 102, on which the reflector 106 is attached, and the other light are reflected by the reflector 106 and then outputted from the other surface of the light guide plate 102. Thus, the dual-face illumination effect may be achieved. This lighting structure sharing the same light source deteriorates the overall brightness, and the power consumption cannot be easily controlled.

FIG. 2 is a schematic illustration showing a conventional backlight structure configured as another example of the dual-face illumination. Referring to FIG. 2, the backlight structure 200 includes two light guide plates 202 and 204, one reflector 206 and two light-emitting elements 208 and 210. What is different from the backlight structure 100 is that the two light guide plates 202 and 204 do not share the same light source. Instead, the two light-emitting elements 208 and 210 respectively supply light to the two light guide plates 202 and 204 so as to achieve the dual-face illumination effect. The light-emitting elements 208 and 210 are respectively disposed on the corresponding FPCs 212 and 214 so that the required powers may be respectively obtained. Such a design has a better optical quality than the backlight structure 100, and the power consumption control thereof is easier than that of the backlight structure 100. However, two FPCs 212 and 214 are needed. So, the manufacturing cost of the FPCs is thus increased.

### SUMMARY OF THE INVENTION

It is therefore an object of the invention to provide a backlight module and a FPC (Flexible Printed Circuit) having light-emitting elements. The backlight module has a dual-face illumination design with better optical quality, and the cost of disposing the light-emitting elements on the FPC may be reduced.

The invention achieves the above-identified object by providing a FPC (Flexible Printed Circuit) having light-emitting elements. The light-emitting elements on the FPC supply light to a first light guide plate and a second light guide plate. The first light guide plate is opposite to the second light guide plate. The FPC includes a first set of light elements, a second set of light elements and a turning port. The second set of light elements and the first set of light elements are disposed at the same side of the FPC. The turning port is situated between the first set of light elements and the second set of light elements. After the turning port is turned, the first set of light elements supplies light to the first light guide plate, and the second set of light elements supplies light to the second light guide plate.

The invention also achieves the above-identified object by providing a backlight module, which includes a first light guide plate, a second light guide plate and a FPC (Flexible Printed Circuit). The second light guide plate is opposite to the first light guide plate. The FPC includes a first set of light elements, a second set of light elements and a turning port. The first set of light elements and the second set of light elements are disposed on the FPC. The turning port is situated between the first set of light elements and the second set of light elements. After the turning port is turned, the first set of light elements supplies light to the first light guide plate, and the second set of light elements supplies light to the second light guide plate.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a conventional backlight structure configured as an example of a dual-face illumination.

FIG. 2 is a schematic illustration showing a conventional backlight structure configured as another example of the dual-face illumination.

FIG. 3A is a schematic illustration showing a lighting module according to a first embodiment of the invention.

FIG. 3B is a schematic illustration showing a FPC 306 of FIG. 3A, which is configured to a new shape.

FIG. 3C is a schematic illustration showing another FPC 306 having light-emitting elements.

FIG. 4 is a schematic illustration showing a backlight structure using the lighting module according to the first embodiment of the invention.

FIG. 5 is a schematic illustration showing a circuit of the FPC 306.

FIG. 6A is a schematic illustration showing a lighting module according to a second embodiment of the invention.

FIG. 6B is a schematic illustration showing a FPC 406 of FIG. 6A, which is configured to a new shape.

FIG. 7 is a schematic illustration showing a backlight structure using the FPC according to the second embodiment of the invention.

FIG. 8A is a schematic illustration showing a lighting module according to a third embodiment of the invention

FIG. 8B is a schematic illustration showing a FPC 506 of FIG. 8A, which is configured to a new shape.

FIG. 9 is a schematic illustration showing a backlight structure using the lighting module according to the third embodiment of the invention.

### DETAILED DESCRIPTION OF THE INVENTION

The invention provides a backlight structure and a lighting module therefor, wherein the optical quality of the dual-face illumination of the backlight structure is better and the cost of disposing the light-emitting elements on the FPC (Flexible Printed Circuit) may be reduced.

The lighting module includes a first set of light elements, a second set of light elements and a FPC (Flexible Printed Circuit). The FPC may be, for example, a flexible printed circuit board. The FPC further has a turning port, which has a single-layered structure. The turning port is situated between the first set of light elements and the second set of light elements. After the turning port is turned, the FPC is configured to a new shape such that the first set of light elements supplies light to a first light guide plate and the second set of light elements supplies light to a second light guide plate, and the dual-face illumination effect is achieved.

### First Embodiment

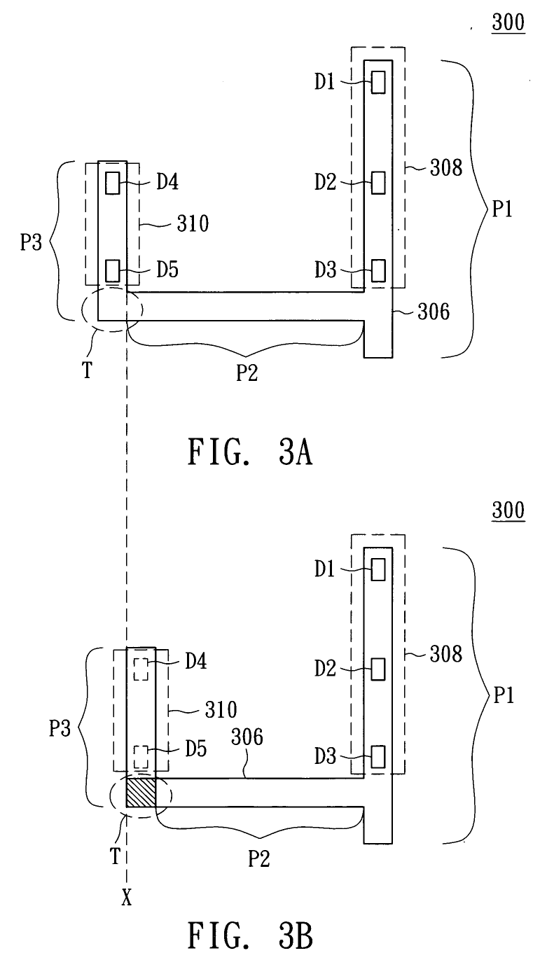

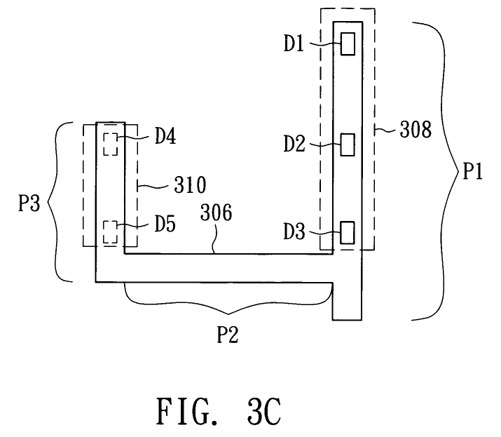

FIG. 3A is a schematic illustration showing a lighting module according to a first embodiment of the invention. Referring to FIG. 3A, the lighting module 300 includes a first set of light elements 308, a second set of light elements 310 and a FPC 306 having a turning port T. The FPC 306 that is not configured to a new shape is illustrated in FIG. 3A. The FPC 306 may have a double-layered structure or a single-layered structure. The first set of light elements 308 and the second set of light elements 310 may be disposed on the same side of the FPC 306, for example. The first set of light elements 308 includes, for example, three electroluminescent elements D1, D2 and D3. The second set of light elements 310 includes, for example, two electroluminescent elements D4 and D5. The electroluminescent element D may be, for example, a light-emitting diode (LED). The turning port T is situated between the first set of light elements 308 and the second set of light elements 310, and has a single-layered structure such that the turning port T may be turned more easily.

In addition, the FPC 306 is further divided into a first portion P1, a second portion P2 and a third portion P3. The first portion P1, the second portion P2 and the third portion P3 are connected in series to form a specific shape, such as an “U” shape, as shown in FIG. 3A. The first set of light elements 308 is disposed on the first portion P1, and the second set of light elements 310 is disposed on the third portion P3.

FIG. 3B is a schematic illustration showing the FPC 306 of FIG. 3A, which is configured to a new shape. As shown in FIG. 3B, the FPC 306 is configured to a new shape by rotating the third portion P3 about the dashed line X (e.g., a long side of the third portion P3) such that a portion of the third portion P3 overlaps with a portion of the second portion P2, an the overlapped portion serves as the turning port T. Thus, the light-emitting element 308 on the first portion P1 and the light-emitting element 310 on the third portion P3 face opposite directions. It is to be noted that the first set of light elements 308 and the second set of light elements 310 may also be disposed on different sides of the FPC 306 in this embodiment. FIG. 3C is a schematic illustration showing another FPC 306 having light-emitting elements. As shown in FIG. 3C, the light-emitting elements 308 and 310 are disposed on different sides of the FPC 306 such that the light-emitting elements 308 and 310 face opposite directions without the FPC 306 being turned.

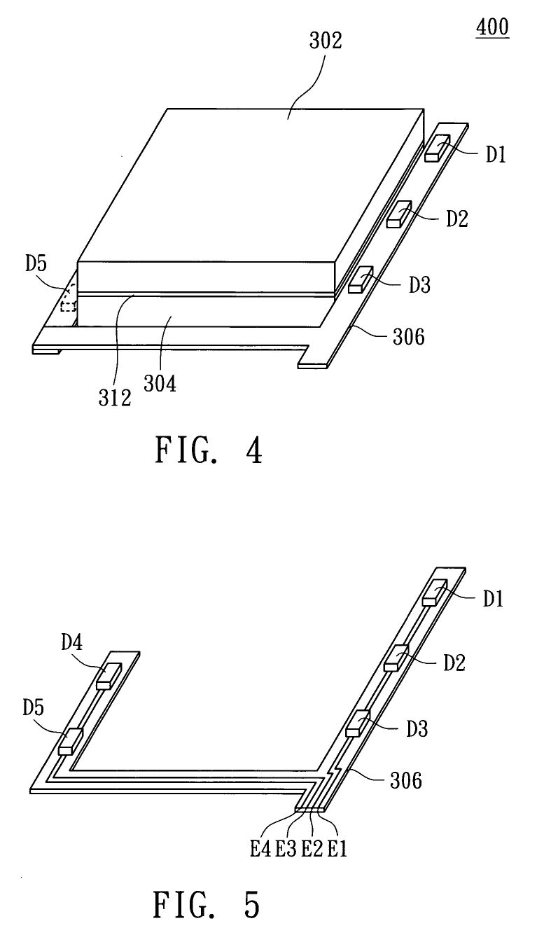

FIG. 4 is a schematic illustration showing a backlight structure using the lighting module according to the first embodiment of the invention. Referring to FIG. 4, the backlight structure 400 includes a first light guide plate 302, a second light guide plate 304, a reflector 312 and the lighting module 300. The first light guide plate 302 and the second light guide plate 304 face opposite directions and are spaced apart by the reflector 312. The FPC 306, which is configured to a new shape, is disposed beside the light guide plates 302 and 304, such that the first set of light elements 308 supplies light to the first light guide plate 302 and the second set of light elements 310 supplies light to the second light guide plate 304. The light guide plates 302 and 304 respectively guide out the light of the light-emitting elements 308 and 310 reflected by the reflector 312 so as to achieve the dual-face illumination effect.

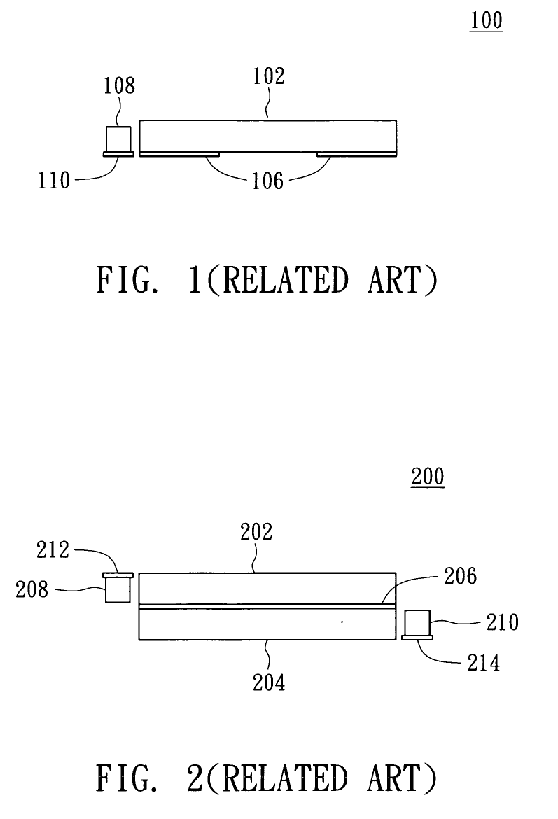

The two light guide plates 302 and 304 may obtain the desired light from the corresponding light-emitting elements 308 and 310. Compared to the conventional backlight structure (e.g., the backlight structure 100 of FIG. 1), which shares the same light source, the brightness of the light guide plates 302 and 304 is higher and can be respectively controlled, and the better optical brightness effect may be obtained.

In addition, multiple electroluminescent elements D may be electrically connected in series or in parallel and disposed on the FPC 306, and the electrical connection method of the electroluminescent elements D on the FPC 306 is not particularly restricted. FIG. 5 is a schematic illustration showing a circuit of the FPC 306. Taking the FPC 306 as an example, the electroluminescent elements D1, D2 and D3 are serially disposed on the first portion P1, and the electroluminescent elements D4 and D5 are serially disposed on the third portion P3. The FPC 306 further has a first electrical connection point E1, a second electrical connection point E2, a third electrical connection point E3 and a fourth electrical connection point E4. A first current I1 for driving the first set of light elements 308 (the electroluminescent elements D1, D2 and D3) to emit light is inputted from the first electrical connection point E1, and is outputted at the second electrical connection point E2. A second current I2 for driving the second set of light elements 310 (the electroluminescent elements D4 and D5) to emit light is inputted from the third electrical connection point E3 and outputted at the fourth electrical connection point E4.

Using two powers to control the lighting powers of the two light-emitting elements 308 and 310 can respectively control the lighting brightness of the two light guide plates 302 and 304. For example, when the lighting module 300 is applied to a mobile telephone having two displays such as a main screen and a sub-screen, the two light guide plates 302 and 304 respectively correspond to the main screen and the sub-screen. When the user opens the mobile telephone to use the main screen, the current I1 drives the first set of light elements 308 to emit light such that frames are displayed on the main screen and the second set of light elements 310 is shut off. On the contrary, when the sub-screen is used to display frames, the second set of light elements 310 is driven and the first set of light elements 308 is shut off. Consequently, compared to the backlight structure sharing one light source, the power consumption may be reduced, and the better power consumption control may be achieved.

When the FPC 306 is manufactured, different manufacturing costs have to be paid according to the positions of the light-emitting elements 308 and 310 bonded on the FPC 306 and the number the FPCs 306. The light-emitting elements 308 and 310 in this embodiment are disposed on the same FPC 306. Compared to the prior art method of disposing the light-emitting elements on two FPCs 212 and 214 in FIG. 2, the cost of disposing the elements on the same FPC 306 in this embodiment is lower.

The manufacturing costs of disposing the light-emitting elements on the same side or different sides of the FPC are also different. If two light-emitting elements are disposed on different sides of the FPC, the side on which the elements are disposed and bonded has to be changed, the wire has to be changed, and the settings on the machine has to be reset and corrected. Thus, the time of bonding the elements is thus lengthened. In this embodiment, the light-emitting elements 308 and 310 are disposed on the same side of the FPC 306, so the time and cost of bonding the FPC 306 may be shortened and reduced, respectively.

### Second Embodiment

In the second and first embodiments, the same elements are denoted by the same symbols.

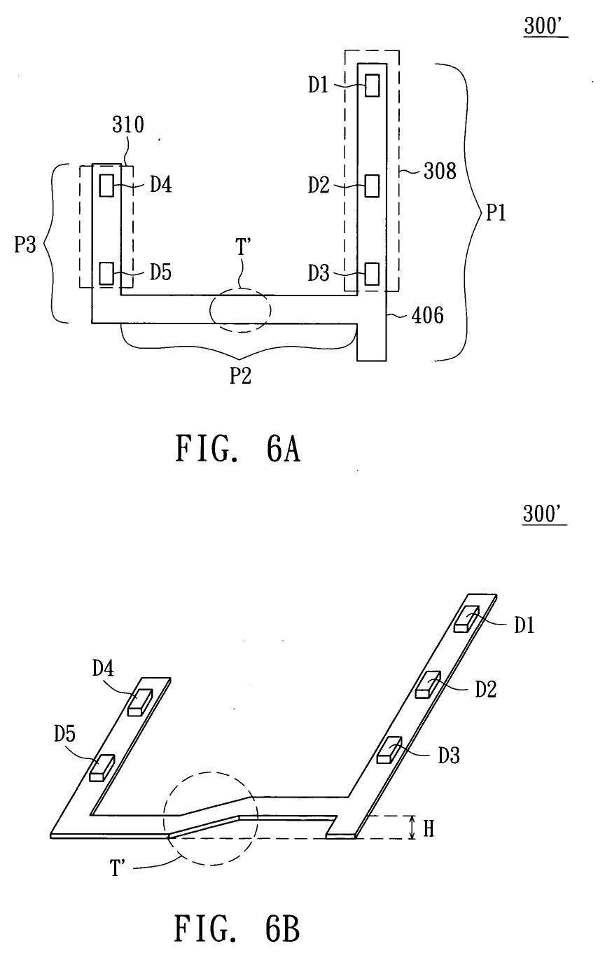

FIG. 6A is a schematic illustration showing a lighting module according to a second embodiment of the invention. Referring to FIG. 6A, the lighting module 300′ includes a first set of light elements 308, a second set of light elements 310, and a FPC 406 having a turning port T′. The FPC 406 that is not configured to a new shape is illustrated in FIG. 6A. Similarly, the turning port T′ is situated between the first set of light elements 308 and the second set of light elements 310, and has a single-layered structure. The FPC 406 and the FPC 306 have the similar shape, i.e., the FPC 406 and the FPC 306 are substantially U-shaped.

FIG. 6B is a schematic illustration showing the FPC 406 of FIG. 6A, which is configured to a new shape. The FPC 406 of this embodiment is configured to a new shape in a manner different from that of the first embodiment, wherein the third portion P3 is not rotated, and only the second portion P2 is turned, such that the first set of light elements 308 and the second set of light elements 310 are disposed at different horizontal planes, and a step height H is formed, as shown in FIG. 6B, to serve as the turning port T′.

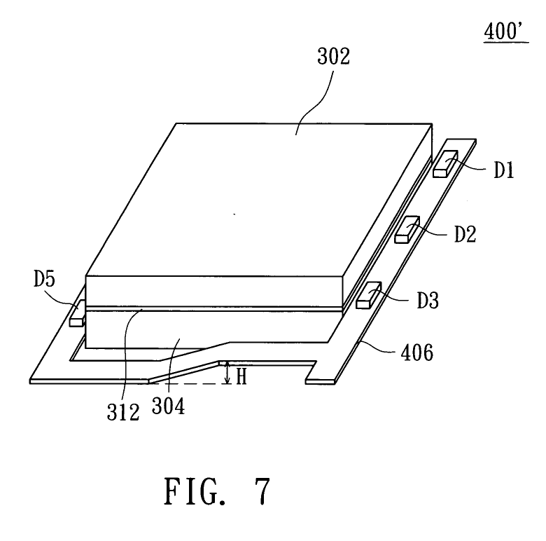

FIG. 7 is a schematic illustration showing a backlight structure using the FPC according to the second embodiment of the invention. Referring to FIG. 7, the backlight structure 400′ includes a first light guide plate 302, a second light guide plate 304, a reflector 312 and a lighting module 300′. The backlight structure 400′ works in a manner similar to that of the first embodiment. As shown in FIG. 7, the FPC 406, which is configured to a new shape, is disposed beside the two light guide plates 302 and 304, such that the first set of light elements 308 supplies light to the first light guide plate 302 and the second set of light elements 310 supplies light to the second light guide plate 304, and the dual-face illumination effect may be achieved.

Consequently, the backlight structure 400′ of this embodiment is the same as the backlight structure 400 of the first embodiment, and thus the better optical brightness effect and the better power consumption control may be achieved as compared with the backlight structure 100 which shares the same light source. The light-emitting elements 308 and 310 are also disposed on the same FPC 406 and the same side of the FPC 406, so the time for bonding the FPC 406 and the manufacturing cost may be respectively shortened and reduced. In addition, the first set of light elements 308 and the second set of light elements 310 of this embodiment may also be disposed on different sides of the FPC 406 to achieve the dual-face illumination effect.

### Third Embodiment

In the third, second and first embodiments, the same elements are denoted by the same symbols.

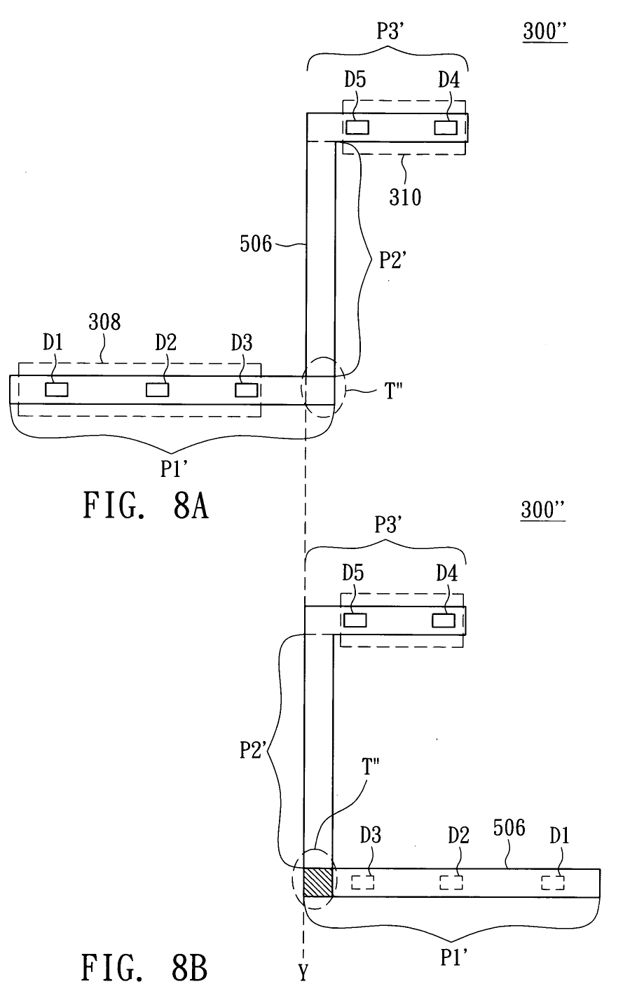

FIG. 8A is a schematic illustration showing a lighting module according to a third embodiment of the invention. Referring to FIG. 8A, the lighting module 300″ includes a first set of light elements 308, a second set of light elements 310 and a FPC 506 having a turning port T″. The FPC 506 that is not configured to a new shape is illustrated in FIG. 8A. The FPC 506 differs from the FPCs 306 and 406 in the shape of the FPC 506 and the position of the turning port T″. The turning port T″ is described in the following.

The FPC 506 is also divided into a first portion P1′, a second portion P2′ and a third portion P3′. The first portion P1′, the second portion P2′ and the third portion P3′ are serially connected to form a “Z” shape, as shown in FIG. 8A. The first portion P1′ and the second portion P2′ are substantially perpendicular to each other. The second portion P2′ and the third portion P3′ are substantially perpendicular to each other. The first set of light elements 308 is disposed on the first portion P1′, the second set of light elements 310 is disposed on the third portion P3′, and the light-emitting elements 308 and 310 are also disposed on the same one plane of the FPC 506. FIG. 8B is a schematic illustration showing the FPC 506 of FIG. 8A, which is configured to a new shape. As shown in FIGS. 8A and 8B, the first portion P1′ is rotated about the dashed line Y (e.g., a long side of the second portion P2′) such that a portion of the first portion P1′ overlaps with a portion of the second portion P2′, and the overlapped portion serves as the turning port T″.

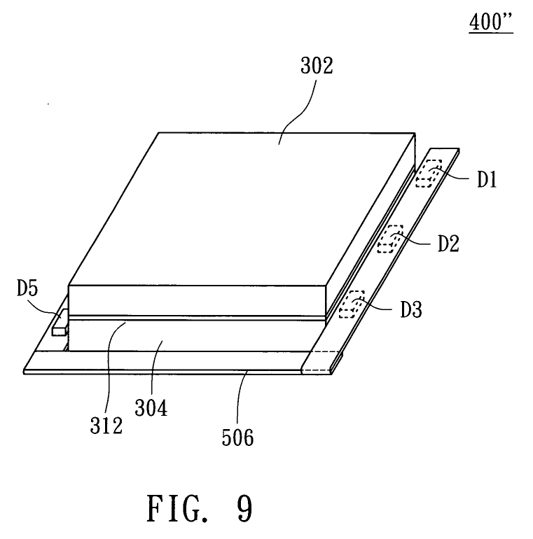

FIG. 9 is a schematic illustration showing a backlight structure using the lighting module according to the third embodiment of the invention. The backlight structure 400″ is similar to the above-mentioned structure, and detailed descriptions thereof will be omitted. As shown in FIG. 9, the FPC 506 that is configured to a new shape is disposed beside the light guide plates 302 and 304, such that the first set of light elements 308 supplies light to the first light guide plate 302 and the second set of light elements 310 supplies light to the second light guide plate 304, and the dual-face illumination effect may be achieved.

Similar to the first and second embodiments, the backlight structure 400″ of the third embodiment has the better optical brightness effect and the better power consumption control may be achieved as compared to the backlight structure 100 which shares the same light source. In addition, the light-emitting elements 308 and 310 are also disposed on the same side of the FPC 506, and the manufacturing cost of the FPC 406 may be reduced. As mentioned hereinabove, however, the light-emitting elements 308 and 310 may also be disposed on different sides of the FPC 506, such that the configured state is illustrated in FIG. 8B. In addition, the three embodiments do not intend to limit the FPC to have the single-layered or double-layered structure. Instead, the structure capable of achieving the dual-face illumination effect after the FPC is configured to a new shape is accepted.

Consequently, the backlight structure and the FPC having light-emitting elements according to the embodiments of the invention can reduce the cost of bonding the light-emitting elements on the FPC when the two sets of light elements are disposed on the same side of the FPC. In addition, the FPC, which is configured to a new shape, has an unlimited shape such that the two sets of light elements respectively supply light to the two light guide plates, and the dual-face illumination effect may be achieved.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lighting module for supplying light to a first light guide plate and a second light guide plate, the lighting module comprising:
a flexible printed circuit (FPC) having a turning port;
a first set of light elements disposed on the FPC; and
a second set of light elements disposed on the FPC, wherein the turning port is situated between the first set of light elements and the second set of light elements.

2. The lighting module according to claim 1, wherein the first set of light elements and the second set of light elements are disposed on the same side of the FPC.

3. The lighting module according to claim 1, wherein the first set of light elements and the second set of light elements are disposed on different sides of the FPC.

4. The lighting module according to claim 1, wherein the FPC has a single-layered structure at the turning port and a double-layered structure at a portion other than the turning port.

5. The lighting module according to claim 1, wherein the first set of light elements comprises a plurality of electroluminescent elements serially disposed on the FPC.

6. The lighting module according to claim 5, wherein the FPC has a first electrical connection point and a second electrical connection point.

7. The lighting module according to claim 1, wherein the second set of light elements comprises a plurality of electroluminescent elements serially disposed on the FPC.

8. The lighting module according to claim 7, wherein the FPC has a third electrical connection point and a fourth electrical connection point.

9. The lighting module according to claim 1, wherein the first set of light elements has a plurality of electroluminescent elements disposed in parallel on the FPC.

10. The lighting module according to claim 1, wherein the second set of light elements has a plurality of electroluminescent elements disposed in parallel on the FPC.

11. The lighting module according to claim 1, wherein the FPC is substantially U-shaped.

12. The lighting module according to claim 1, wherein the FPC is substantially Z-shaped.

13. A backlight structure, comprising:
a first light guide plate;
a second light guide plate opposite to the first light guide plate; and
a flexible printed circuit (FPC) having a first set of light elements and a second set of light elements, wherein the first set of light elements supplies light to the first light guide plate, and the second set of light elements supplies light to the second light guide plate.

14. The backlight structure according to claim 13, wherein the FPC further has a turning port between the first set of light elements and the second set of light elements.

15. The backlight structure according to claim 14, wherein the second set of light elements and the first set of light elements are disposed on the same side of the FPC.

16. The backlight structure according to claim 14, wherein the second set of light elements and the first set of light elements are disposed on different sides of the FPC.

17. The backlight structure according to claim 14, wherein the FPC has a substantially U-shaped.

18. The backlight structure according to claim 14, wherein the FPC has a substantially Z-shaped.
